(19) United States
(12) Patent Application Publication
(10) Pub. No.: US 2018/0186210 A1
(43) Pub. Date: Jul. 5, 2018

(54) Method for Efficiently Transmitting a Road-Surface Contour Profile

(71) Applicant: AUDI AG, Ingolstadt (DE)

(72) Inventors: Andreas NOLL, Freystadt (DE); Bodo KLEICKMANN, Ingolstadt (DE)

(73) Assignee: AUDI AG, Ingolstadt (DE)

(21) Appl. No.: 15/736,145

(22) PCT Filed: May 31, 2016
(86) PCT No.: PCT/EP2016/000885

§ 371 Date: Dec. 13, 2017

(30) Foreign Application Priority Data
Jun. 16, 2015 (DE) 10 2015 007 670.1

(51) Int. Cl. B60G 17/0165; B60G 17/018

(52) U.S. Cl. CPC B60G 17/0165; B60G 17/018; B60G 2600/71; B60G 2400/821; B60G 2400/204

(57) ABSTRACT

A method for transmitting information between a motor vehicle and a vehicle-external server. A contour profile of a road to be traveled along by the vehicle, which is stored on the server, is retrieved by the vehicle via a vehicle-server interface. The contour values of the road contour profile lying ahead of the vehicle are cyclically transmitted by the server to the vehicle at a definable interval. A contour value is transmitted per cycle, which lies ahead of the vehicle at a speed-dependent interval. In addition, a chassis system for carrying out the method and a vehicle are provided with the chassis.

The invention relates to a method for transmitting a contour profile of a road to a vehicle.

Modern vehicles are provided with many support systems designed to improve safety and driving comfort. One of the systems exerting influence on the driving and riding comfort is the suspension of the vehicle. The suspension is part of the chassis. The effect of the suspension is that the bumps of uneven ground surfaces will not be transmitted directly to the motor vehicle, but instead, as the tire of the vehicle follows these uneven ground surfaces, the contact with the ground is limited. However, sufficient contact with the ground or sufficient ground traction is of decisive importance for the safety of the vehicle and of its occupants.

In order to compensate for the movements that are transmitted to the suspension, the suspension is provided with shock absorbers which prevent rocking of the vehicle. Over time, suspension systems have been developed which can actively intervene in the state of the subsystem. Active suspension systems generate additional forces or movements in order to maintain an even better contact with the ground and to suppresses rocking movements of the chassis.

Since the suspension only reacts to a bumpy ground surface, current trends being considered are in the area of predictive systems. Such systems use information, which is stored centrally or remotely, in order to make it possible to predict eminent events and to adjust the chassis accordingly. For this purpose, it is necessary to supply to the system information about the course of the road and/or about the state of road.

Since there are many systems that are present and networked with each other in the vehicle, the amount of data that needs to be transmitted within the vehicle continues to increase. The amount of data is even greater when the vehicle needs to communicate with external servers, for example to transmit personal data from a so-called cloud service to the motor vehicle, or to transmit the navigation data of a navigation system. In addition, more and more data is transmitted to the vehicle, which is not available directly to the drier, but used for different driving functions to improve the driving comfort and safety. To this category of data belongs for example recognition of vehicle plates, or determination of road conditions.

Systems for determinations of road conditions are described in US 2012/0203428 A1 and in U.S. Pat. No. 6,763,292 B1.

Information about road conditions is available for example through various services and platforms via the internet. It is foreseeable that other functions will be added in the vehicle which communicate with the internet. For that reason, a method is sought to make it possible to select large amounts of data that are stored on servers in the internet and to limit them depending on the data connection between the server and the vehicle.

Therefore, a method is proposed for transmission of information between a vehicle and a server having the features of the claim 1. Furthermore, a chassis system having the features of claim 11 is proposed.

Other embodiments will become evident from the description and from the dependent subclaims.

According to the invention, a method is proposed for transmitting information between a vehicle and a server that is external to the vehicle, wherein the contour profile of a road to be traveled along by a vehicle, which is stored on the server, is retrieved by the vehicle via a vehicle server interface, wherein the contour values of the road contour profile ahead of the vehicle are cyclically transmitted, which is to say transmitted at a definable time interval, and wherein an elevation value is transmitted per cycle, which is ahead of the vehicle at a distance depending on the speed.

In one embodiment of the method according to the invention, the vehicle has a left and a right driving lane, and an elevation value to be transmitted from the server to the vehicle comprises in each case a value for the left driving lane and a value for the right driving lane of the vehicle.

In another embodiment according to the invention, a plurality of transmitted elevation values generates an elevation profile for both the left and for the right lane of the vehicle.

In yet another embodiment of the method according to the invention, a plurality of transmitted contour values generates respectively a contour profile for the left and for the left lane of the vehicle.

In yet another embodiment of the method according to the invention, the transmitted contour values are handed over to a control unit of the vehicle, which processes the contour value and adapts the chassis of the vehicle to the contour profile that can be expected in this manner.

In one embodiment of the method according to the invention, the stabilization and/or damping characteristics of the vehicle or of the chassis are adjusted.

In another embodiment of the method according to the invention, the contour profile created when the vehicle or the chassis is driven is determined each time for the left driving lane and for the right driving lane and transmitted to a vehicle-external server.

Furthermore, according to the invention, a chassis system of a vehicle that is provided with a control unit is proposed, which is configured to transmit cyclically, i.e. at a definable time interval, via a vehicle-server interface to a vehicle-external server the contour values of a vehicle-external server, which provides contour values of a road profile of a road to be traveled along by a vehicle, wherein the contour values of the road contour profile that is located in front of the motor vehicle are transmitted in reaction to a cyclical request that is sent from the server to the vehicle in a corresponding cycle, and wherein a contour value is transmitted per cycle.

In one embodiment of the chassis system according to the invention, the contour value comprise a value for a left driving lane, and for a right driving lane of the vehicle.

In one embodiment of the chassis system according to the invention, the chassis system comprises a control unit, which is configured to process the received contour values and to adjust accordingly the stabilization and/or damping properties of the chassis.

In yet another embodiment of the chassis system according to the invention, each lane has at least one sensor, which is configured to measure the contour profile that has been traveled along by at least one of the tires of the vehicle and to transmit the contour values.

According to the invention, a vehicle that is provided with a chassis system in order to carry out the method according to the invention is also proposed.

It goes without saying that the features mentioned above and those that will be discussed below can be used not only in the respectively indicated combination, but also in other combinations or individually, without deviating from the scope of the present invention.

The invention is further schematically illustrated in detail based on embodiments with reference to figures.

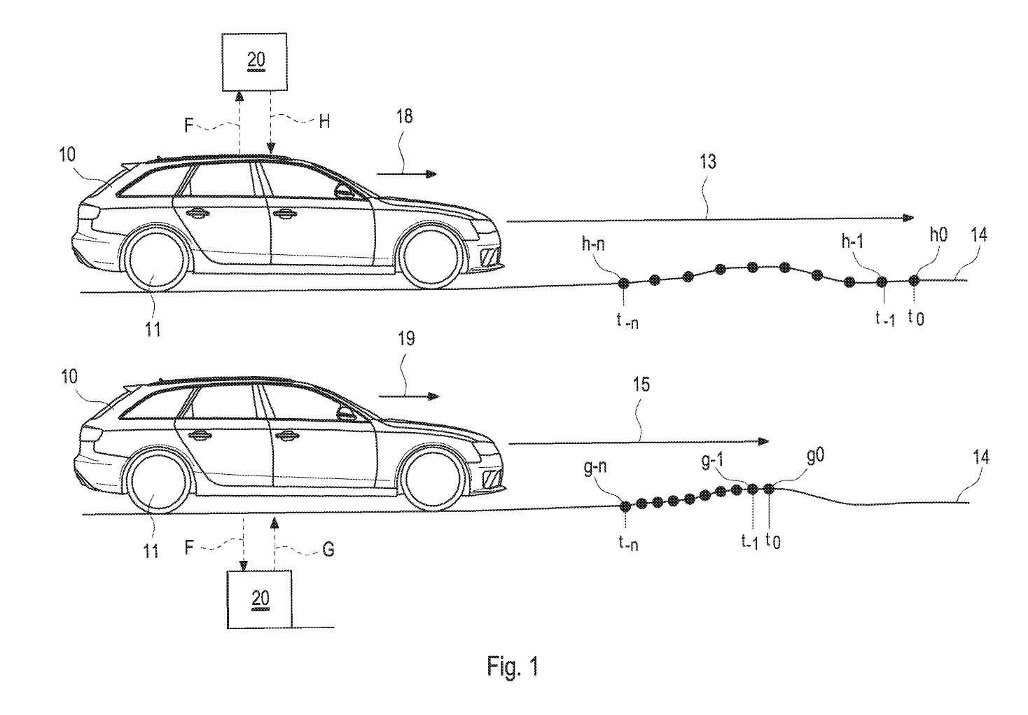

FIG. 1 shows in a divided illustration of a contour profile and contour values to be transmitted with two mutually different speeds.

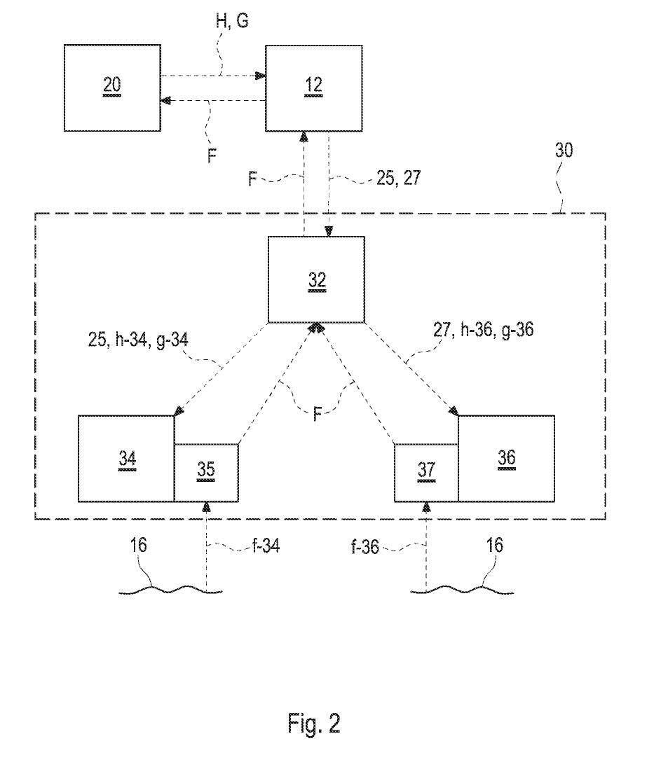

FIG. 2 shows a schematic view of devices participating in an embodiment of the method according to the invention.

The principle underlying the invention will now be explained with reference to FIGS. 1 and 2. Targeted networking by means of a global server system 20 makes it possible to transmit a road contour profile 14 between a vehicle 10 and a server 20. The information about the road contour profile 14 is provided to vertical dynamic systems in the vehicle 10, which adjusts a chassis 30 (see FIG. 2) based on the obtained information and creates a targeted increase of comfort.

The aim is to ensure an efficient transmission of information about the road contour profile 14 between the vehicle 10 and the server 20. Efficient transmission is designed to minimize the amount of data to a minimum and to ensure that also in areas with week signal (for example on rural roads and/or in insulated areas (for example due to a tunnel, house walls, etc.), a sufficient contour profile can be transmitted.

FIG. 1 illustrates the resolution of the transmitted contour values H with two different speeds 18, 19 (indicated in each case by an arrow). In the upper part of FIG. 1, the vehicle 10 is moving at speed 18 along the road surface 14. At this time, namely at point in time tO, the vehicle 10 receives the contour value h0. The contour value h0 is the contour value which the vehicle will be driving over for example in 1 second and which thus lies ahead of the vehicle at a corresponding timely defined interval 13. Previously, the vehicle has already received the contour values h-1 through h-n. The totality of the received contour values h0, hl, . . . , h-n generates a road contour profile h-34, h-36 (FIG. 2), respectively, for a left and for a right driving lane of the vehicle.

In the lower part of FIG. 1, the vehicle 10 is moving with the speed 19, which corresponds for example to a half of the speed 18, along the road contour profile 14. At this point in time, the vehicle 10 receives the contour value g0. The contour value g0 is the contour value that the vehicle 10 will drive over in 1 second and it thus lies at a corresponding interval 15 ahead of the vehicle 10. Previously, the vehicle has already received contour values g-1 through g-n. The totality of the received contour values g0, g-1, . . . , g-n generates a street contour profile g-34, g-36 (FIG. 2), respectively, for the left and for the right driving lane of the vehicle.

Since the speed 19 is lower, although a time interval at which the inquiries are sent to the server 20 has remained the same in this example, the contour value g0, g-1, g-n are closer to each other than in the upper part of FIG. 1. The spatial distance between the two adjacent contour values is calculated from the vehicle speed 18, 19 and from the time between two queries. Accordingly, at a lower speed 19, the resolution of the contour profile on the side of the vehicle is higher because the contour values are closer to each other. In other words, the time between two queries to the control unit 32 can be increased at a lower speed 19, or it can be decreased at a higher speed 18.

The distance 13, 15 of the contour value H, G from the current position of the vehicle is speed-dependent. The interval 13, 15 of the requested and transmitted contour value H, G relates to the contour value that the vehicle 10 will drive over with the current speed 18, 19, for example 1 second later. This results in the spatial distance 13, 15 of the requested contour value H, G from the time after which the requested contour value H, G is to be reached by the vehicle 10 and the current speed of the vehicle. If the spatial distance 13, 15 ahead of the vehicle 10 is too high or too low, the spatial interval of the requested or transmitted contour value H, G can be increased or decreased. When the contour value H, G that is driven through by the vehicle 10 for example in 1 second exceeds a determinable value, the time interval can be lowered, so that a contour value is requested which relates to the location that the vehicle will now be passing through in 0.5 seconds. The same applies if the spatial distance 13, 15 is too small, so that the time intervals is then increased.

During the time when the vehicle 10 passes through the street profile 14, the sensors 35, 37 (FIG. 2) measure the contour profile 16 through which the vehicle actually traveled (FIG. 2) and transmit the measured contour profile F to the server 20 in order to improve the quality of the stored contour profile.

The road contour profile F, f-34, f-36 generated on the vehicle-side according to the method of this invention is characterized by speed-dependent scanning, and simultaneously also by a constant time bandwidth of the communication interface or of the vehicle-side server interface 12. Therefore, the resolution of the road contour profile 14 on the server 20 may be significantly higher, while a high contour value H, G can be still transmitted in a speed-dependent resolution in front of the motor vehicle 10. The server 20 is designed to receive a road profile that has been actually traveled through from a plurality of vehicles 10 participating in the traffic. Therefore, a high density of discrete contour values H, G of the road profile 14 is provided for discrete contour value H, G of the road profile 14. One vehicle 10 that travels through a road profile 14 at a speed 18, 19 of for example 60 kilometers per hour and sends a request to the server 20 every 5 milliseconds, covers a distance of 8.3 millimeters every 5 milliseconds. A resolution of 8.3 mm on the server 20 would thus be sufficient in order to handle the queries of the vehicle 10. However, the resolution on the server 20 that is in fact provided can be significantly higher, namely as the data or contour values H, G which are stored at intervals of less than 8.3 mm. It should be also noted that a continuous road profile 14 can be stored, as well as only the discrete contour values H.

As shown in FIG. 2, the chassis 30 of the vehicle 10 is provided with a vehicle-server interface 12 and with a control unit 32 of the chassis 30. The control unit 32 operates in a cycle. One cycle comprises a calculation of a location that is in front of the vehicle 10 from which a contour value H, G is to be requested, as well as the transmission of the request to the vehicle-server interface 12 or server 20, the reception of the of the contour value 25, 27 and when appropriate also transferring a contour profile that has been actually traveled along to the vehicle-server interface 12 or to the server 20.

During one cycle, one location of the road profile 14, which will be traveled along by the vehicle 10 at the current speed 18, 19, for example in 1 second, is calculated. This information is transmitted to the vehicle-server interface 12, which then sends a request for transmitting a contour value H at the calculated location to the server 20. The server 20 transfers the requested contour value H to the vehicle-server interface 12. The contour value H comprises a left contour value 25 and a right contour value 27, respectively, for the left or the right driving lane 34, 36 of the vehicle 10. The control unit 32 receives the contour values 25, 27 and forwards them to the respective control systems of the driving lanes 34, 36. After that, the suspension of the driving lanes 34, 36 can be adjusted to the contour value 25, 27.

One contour value 25 is transmitted for the left driving lane 34 of the vehicle 10 per cycle, and one contour value 27 is transmitted for the right driving lane 36 of the vehicle 10 per cycle. The contour values 25, 27 received over time by the control unit 32 generate a unique image h-34, h-36 of the road contour profile 14 for the left and for the right driving lane 34, 36 of the vehicle 10 in front of the vehicle 10. The road contour profile h-34, h-36 generated in the vehicle 10 by the control unit 32 differs from the road contour profile 14 that is stored on the server 20 because the resolution, which is to say how close the two contour values H are to each other, depends on the driving speed 18, 19 and on the time that elapses between two requests of the control unit 32 (see FIG. 1). As was already mentioned, the time of the cycle can be also changed as a function of the speed 18, 19.

While the road is being traveled along, the sensors 35, 37 detect the chassis 30 respectively for the left or for the right driving lane 34, 36 of the contour profile 16 of the street that the vehicle is currently traveling on. The road contour F that is detected by the sensors 35, 37 is compared to the data received by the server 20, the data is fused and sent back to the server. The quality of the road contour profile 14 can thus be improved in this manner.

This cycle is repeated in very short time intervals. However, the time of the cycle, which is to say the time between two requests sent to the server 20, can be speed-dependent. At higher speeds 18, the time of the cycle may be set to a lower value, for example to 5 milliseconds. At a lower speed 19, a value of for example 15 milliseconds may be sufficient.

Within the context of the invention is also included that case when the control unit 32 takes over the tasks of the vehicle-server interface 12 and vice versa.

Today's telecommunication systems, such as for example LTE, allow maximum data rates of up to 300 megabits per second (MBit/s) and they make it possible to transmit the amount of data that is required for the method according to the invention. However, as was already mentioned, in rural areas and under shielded conditions, this data rate may be reduced to a small percentage thereof. The method according to the invention requires for the transmission of a road contour for the left and for the right driving lane a data rate of approximately 0.0008 MBit/s and it is therefore suitable also for a reliable transmission of the contour values at a low data rate h.

1-12. (canceled)

13. A method for transmitting information between a motor vehicle and a vehicle-external server, wherein a contour profile for a road to be traveled along by the vehicle, which is stored on the server, is retrieved by the vehicle via a vehicle-server interface, wherein contour values of the contour profile lying ahead of the vehicle are transmitted by the server to the vehicle cyclically, at a definable time interval, wherein one contour value is transmitted per cycle, which lies at a speed-dependent distance ahead of the vehicle.

14. The method according to claim 13, wherein the vehicle is provided with a left and with a right driving lane and a contour value to be transmitted by the server to the vehicle includes in each case a left contour value for the left driving lane and a right contour value for the right driving lane of the motor vehicle.

15. The method according to claim 14, wherein a plurality of transmitted contour values generates a contour profile, respectively, for the left and for the right driving lane of the vehicle.

16. The method according to claim 15, wherein the transmitted contour values are sent to a control unit of the motor vehicle, which processes the contour values and adjusts a chassis of the vehicle to the expected contour profile.

17. The method according to the claim 16, wherein stabilization and/or damping features of the motor vehicle or of the chassis are adjusted.

18. The method according to claim 15, wherein the contour profile traveled along by the vehicle is determined and the contour values for the respective left driving lane and for the right driving lane are transmitted to the vehicle-external server.

19. The method according to claim 13, wherein the time of the cycle, which elapses between two requests sent to the server, is adjusted depending on the speed of the vehicle.

20. A chassis system of a vehicle provided with a control unit, which is configured to request at a definable interval via a vehicle-server interface from a vehicle-external server to send contour values of a contour profile of a road to be traveled along by the vehicle, wherein the contour values of the contour profile lying ahead of the vehicle are transmitted cyclically, at a timely definable interval, wherein one contour value is transmitted per cycle.

21. The chassis system according to claim 20, wherein the contour value is in each case provided with a left contour value for a left driving lane and with a right contour value for a right driving lane.

22. The chassis system according to claim 21, wherein the control unit is configured to process the received contour values and to adjust accordingly stabilization and/or damping features of the chassis.

23. The chassis system according to claim 20, further comprising at least one sensor for each lane, which is configured to measure the respective lane of the contour profile traveled along by at least one tire of the vehicle and to transmit the measured contour values to the server.
